(19) United States
(12) Patent Application Publication
(10) Pub. No.: US 2009/0042044 A1
(43) Pub. Date: Feb. 12, 2009

(54) Novel nanocomposite coating for the reduction of pigment particles loss and UV fade and chemical degradation for decorative & structural products made from concrete and concrete composites

(76) Inventor: David Abecassis, Huntington, NY (US)

Correspondence Address: ATTN: Thomas A. O'Rourke;Bodner & O'Rourke, 425 Broadhollow Road, Melville, NY, 11747, US

(21) Appl. No.: 12/069,734

(22) Filed: Feb. 12, 2008

Related U.S. Application Data
(60) Provisional application No. 60/963,946, filed on Aug. 8, 2007.

(51) Int. Cl. B32B 13/04; B28B 7/36

(52) U.S. Cl. 428/454; 249/114.1

(57) ABSTRACT

Disclosed is a method of bonding a coating material to concrete The process includes applying a coating material to an inner surface of a mold, applying an aqueous solution of a polymeric material and a clay to the coating material and pouring concrete into the mold. Once the concrete is set, the coated concrete is removed from the mold.

### FIELD OF THE INVENTION

The invention is directed towards the decorative and structural concrete markets where pigment particles are added to the surface. The invention is also directed towards concrete markets where the pigment is added into the concrete mix. The invention represents a novel nanocomposite coating for use with structural and decorative concrete products.

### BACKGROUND OF THE INVENTION

Concrete can be molded into a variety of decorative products including artificial stones, mosaics, and brick facades, just to name a few decorative concrete applications. Many of these products achieve their appearance by the use of surface pigments or other surface additives. These pigments are often metal oxides but can be other particles such as synthetic particles, and organics as well. The particles are introduced onto the surface of the mold receiving the concrete. When the concrete is added to the mold, the particles adheres to the pigment. Thus, when hardened the concrete will carry the pigment on its surface creating the desired appearance for the end use (artificial stone, slate, marble etc.). The chemical environment produced in concrete is not conducive to many pigments. The strong alkali nature of the material chemically degrades many pigment species; both mineral and organic over time. It is for this reason that encapsulating pigments with a chemically inert layer that is anchored into the concrete benefits a wide variety of pigments by shielding the pigment from alkali and water.

Calcium silicate hydrate is the primary cementing material which is produced when Portland cement hydrates during the hydration of concrete, The hydrate is very important to strength of the final product. There are other mineral species in concrete as well, such as tricalcium aluminate, and triclacium aluminoferrate, and gypsum, that contribute to concrete curing. These latter compounds are not as critical to strength of the concrete. The latter three species only account for about 25% of the hydration reactive species in the curing. Calcium silicate species including calcium tri-silicate and calcium di-silicate account for about 75% of the critical-to-cure chemicals whose hydration accounts for concrete's physical properties. The calcium silicate species naturally act as the dominant adhesive for pigment particles.

The mineral adhesive layer such as a calcium silicate layer binds the pigment particle to the surface of the decorative concrete. This mineral layer is susceptible to dimensional changes with prolonged contact with water. Further hydration causes swelling at the pigment particle-calcium silicate hydrate interface.

When drying occurs, the interface shrinks. If this cycle is reproduced repeatedly over time, it can cause the particle coating to be loosened and easily carried away by wind or abrasion. This pigment loss causes fading of the decorative concrete over time. Horizontal surfaces are particularly vulnerable since their contact with water is prolonged, when compared with vertical surfaces. This results in a concrete decorative product which loses the natural or finished appearance of the material it is trying to mimic. The resulting product looks more like concrete and less like stone or mosaic, etc. causing problems including problems with customer satisfaction.

UV and chemical attack can also result in pigment fade over the life of the concrete product in the many cases where UV and chemical susceptible pigments are used. The present invention minimizes these effects as well as serving as a mechanical anchor for the pigment or other particles. In addition, the use of nano-sized smectite clay particles forms a protective barrier to slow down the UV and chemical effects in water-dispersed polymers which normally do not perform well in outdoor environments.

### OBJECTS OF THE INVENTION

One object of the invention is to provide the decorative concrete industry with a protective surface finish that is superior to the product currently available.

Yet another object of the invention is to provide an adhesive coating material for concrete surface pigment binding.

Still another object of the invention is to provide an improved blocking agent for moisture transfer and porosity in concrete.

Another object of the invention is to provide a pigment adhesion coating that can be sprayed brushed or dipped onto the surface of the pigmented concrete object.

It is a still further object of the invention to provide a final coating for concrete that contains finely dispersed sodium bentonite clay molecules as additional barrier.

It is also an object of the invention to provide UV resistance in a coating for concrete as the coating binds pigment or other particles to the concrete surface.

Yet another object of the invention is to provide a means to encapsulate and protect concrete surface pigments from UV degradation and chemical attack by reactive chemical species contained in the concrete.

### SUMMARY OF THE INVENTION

The present invention is comprises a water dispersed polymer based coating which has high UV and weathering characteristics, and added barrier-magnifying effects of silicate nanoparticles to the final dry coating film. Typically, the composition contains an aliphatic urethane, but can include other UV and chemically resistant transparent polymers such as water soluble alkyde resins, epoxies, acrylic resins, polyester styrene acrylic resins, vinyl acrylic resins and other water soluble resins which can be dispersed in an aqueous solution Suspended-clay allows for the use of polymers which are normally not as resistant to UV and chemicals by forming a barrier to the latter in the coating dry-film.

### DETAILED DESCRIPTION OF THE INVENTION

The clays used in the present invention are preferably a smectite clay. A smectite clay is a natural or synthetic clay mineral selected from the group consisting of hectorite, montmorillonite, bentonite, beidelite, saponite, stevensite and mixtures thereof. A particularly preferred choice for the smectite is montmorillonite. When these are uniformly dispersed as individual molecules, they form nanocomposites with polymer matrices. In this case they are used to make a water based nanocomposite coating with good properties for the application of pigment retention.

The polymers used are preferably transparent or translucent, and weather the outdoors well due to high chemical and UV resistance. They are also water dispersible and water based in their delivery system. The blend of the clay and polymer dispersions into a coating results in exceptional weathering properties while retaining surface pigments on decorative concrete. A preferred embodiment is aliphatic urethane due to it's low toxicity, ease of handling, and superior weathering properties. Other preferred materials include but are not limited to water soluble alkyde resins, epoxies, acrylic resins, polyester styrene acrylic resins, vinyl acrylic resins and other water soluble resins.

Commercial polyurethane is typically about 30% polyurethane with the remainder mostly water. In forming the composition of the present invention, an aliphatic polyurethane is added to water to form a more dilute aqueous solution. Preferably there is 10-300 g of aliphatic urethane per liter of water. To the aqueous solution of polyurethane 1-100 g of clay are added. The ratio of clay to aliphatic polyurethane is preferably about ⅓-1.3:1. More preferably there is 10 wt. % polyurethane and with 1.5-3 wt % clay in the blend with the remainder water.

In still another embodiment the ratio of materials is about 100 grams of clay to 1000 grams of polyurethane in one liter of water. At lower concentrations of polyurethane such as about 1% by weight polyurethane there is almost as much clay as there is polyurethane, i.e., about 1% clay with the remainder water. Thus the formulation can be a 50-50 blend of polyurethane and clay in an aqueous solution

The surface pigments or other surface additives can also be applied to the concrete after the concrete has been cured and no longer in a liquid state. In this approach, hardened concrete is treated with a coating of an aqueous solution of a water soluble polymeric material and a clay. The solution is applied to the concrete by any suitable means. Over the coating of the aqueous solution the desired surface pigment or other surface additive is applied. The aqueous solution of the polymeric material can be applied to the concrete by dipping, by a spray, by a brush, or other suitable means. Other suitable means includes by robotically applying by an automatic spray booth, a fluidized be process, etc.

After the aqueous solution is applied, the concrete article can be air cured at ambient temperature or at higher temperatures to speed the curing. In addition, the concrete can be heated before the application of the aqueous solution. Curing of the aqueous solution can be accomplished in a variety of ways such as by radiofrequency or the use of a curing agent with or without an accelerant. The curing agent can be an amine or nitrogen containing organic group susceptible to an addition reaction to the polymer phase. The curing agent could be an alcohol or oxygen containing aldehyde, ketone, carbonyl epoxy, ether, ester, organic and or other oxygen containing reactive group capable of addition reactions to the polymer.

### EXAMPLES

### Example 1

Artificial stone made from concrete and surface pigmented with iron oxide (to give a weathered stone appearance) was made when concrete was poured into a PVC elastomer mold containing the iron oxide pigment on the inner mold surface. The samples were roughly 3 inches by five inches in dimension. One surface bore the pigment, and this surface was treated with an aqueous solution of aliphatic polyurethane at 5% by weight solids with 5% by weight sodium bentonite. The 90% remaining is deionized water. The resulting coating visibly augmented pigment retention after subjecting the coated sample and a control to repeated freeze-thaw cycles. After 9 cycles, the samples were removed and subjected to a cloth wipe at moderate pressure. The control sample visibly lost pigment as evidenced by the staining of the control cloth wipe sample. The sample coated with the composition of the present invention was not releasing pigments as evidenced by a non stained white cloth after a coated sample wipe.

The wipe was made with a rough but soft cotton rag and the rub carried out with moderate force (˜'11 b pressure). The coated and control samples were both frozen and then subjected to wipe procedures.

### Example 2

In another example a formulation consisting of 10% solids aliphatic polyurethane and 2% clay was coated onto the above described and manufactured artificial stone and resulted in a shiny version of the coating with similar wipe test results after freeze-thaw.

What is claimed:

1) A method of bonding a coating material to concrete comprising applying said coating material to an inner surface of a mold, applying an aqueous solution of a polymeric material and a clay, pouring concrete into the mold, permitting the concrete to set, removing the concrete from the mold.

2) The method according to claim 1 wherein said polymeric material is an aliphatic polyurethane.

3) The method according to claim 2 wherein the aqueous solution contains 5% by weight aliphatic polyurethane and 5% by weight of a clay.

4) The method of claim 1 wherein the polymeric material used is an alkyde resin.

5) The method of claim 1 wherein the polymeric material is an epoxy.

6) The method of claim 1 wherein the polymeric material is an acrylic resin.

7) The method of claim 1 wherein the polymeric material is a polyester.

8) The method of claim 1 wherein the polymeric material is a styrene acrylic resin.

9) The method of claim 1 wherein the polymeric material is a vinyl acrylic resin.

10) The method of claim 1 wherein the clay is selected from the group consisting essentially of a hectorite, montmorillonite, bentonite, beidelite, saponite, stevensite and mixtures thereof

11) The method of claim 1 wherein the suspended clay molecules are evenly distributed in the aqueous solution.

12) The method of claim 11 wherein said clay molecules form a nanocomposite structure in the final dry film.

13) A weather resistant article comprising concrete containing product and a coating material on an outer surface of at least a portion of said concrete, said coating material secured to said concrete by the application of an aqueous solution of a polymeric material and a clay to said surface of said concrete followed by application of said coating material to said concrete.

14) The article according to claim 13 wherein said polymeric material is an aliphatic polyurethane.

15) The article according to claim 14 wherein the aqueous solution contains 5% by weight aliphatic polyurethane and about 5% by weight of a clay.

16) The article of claim 13 wherein the aqueous solution is applied by dipping.

17) The article of claim 13 wherein the aqueous solution is applied by spray.

18) The article of claim 13 wherein the aqueous solution is applied by a brush.

19) The article of claim 13 wherein the aqueous solution is robotically applied by automatic spray booth.

20) The article of claim 13 wherein the aqueous solution is applied by a fluidized-bed process.

21) The article of claim 13 wherein the article is air cured after application at ambient temperature.

22) The article of claim 13 wherein the product is heat cured after application of the aqueous solution at ambient temperature.

23) The article of claim 13 wherein the concrete is heated prior to the application of the aqueous solution.

24) The article of claim 13 wherein the polymeric material is radiofrequency cured.

25) The article of claim 13 wherein the polymeric material is cured using a curing agent mixed into the aqueous solution prior to application on the concrete.

26) The article of claim 13 wherein said polymeric material is cured by an accelerant mixed into the aqueous solution prior to application on the concrete.

27) The article of claim 25 wherein the curing agent is a compound having an amine or nitrogen containing organic group susceptible to an addition reaction to the polymer phase.

28) The article of claim 25 wherein the curing agent is selected from the group consisting of an alcohol, or oxygen containing aldehyde, ketone, carbonyl, epoxy, ether, ester, organic acid or other oxygen containing reactive group capable of addition reactions to the polymer.
